(19) United States
(12) Patent Application Publication
(10) Pub. No.: US 2008/0199646 A1
(43) Pub. Date: Aug. 21, 2008

(54) Inline Particle Deposition Extrusion

(75) Inventor: Elizabeth Barnes, Melrose, MA (US)

Correspondence Address: MEDTRONIC VASCULAR, INC.;IP LEGAL DEPARTMENT, 3576 UNOCAL PLACE, SANTA ROSA, CA, 95403, US

(73) Assignee: Medtronic Vascular, Inc., Santa Rosa, CA (US)

(21) Appl. No.: 11/675,219

(22) Filed: Feb. 15, 2007

(51) Int. Cl. B29D 23/00

(52) U.S. Cl. 428/36.91; 264/209.1

(57) ABSTRACT

A process for altering the properties of extruded tubing by applying a solid particulate material to a tacky outer surface of the tubing as the tubing exists the extrusion head or die and prior to the tubing entering a cooling system of the extrusion line. The particulate material may act as a tie layer to improve the adherence of a second material to the outer surface of the extruded tubing, thus altering the tensile strength, elongation, and/or stiffness properties of the extruded tubing. In addition, the application of particulate material may be chosen to provide radiopacity to the extruded tubing. The solid particulate material may be deposited on the extruded tubing by vacuum deposition, magnetism, or pressurized means.

### FIELD OF THE INVENTION

The invention relates generally to an extrusion process for forming medical tubing. More particularly, a melt extrusion process includes a particle deposition step that occurs downstream of the extruder die but prior to cooling of the extruder tubing.

### BACKGROUND OF THE INVENTION

Extrusion encompasses various processes that feature low tooling and labor costs, making extrusion a desirable manufacturing process especially for tubular profiles. During a melt extrusion process, a solid thermoplastic polymer material (i.e., pellets, chips, beads, power and the like) is generally fed through a transport section into a rotating screw of an extruder via a feeder or hopper. The polymer material is slowly heated as it is pressed forward toward an extrusion die, becoming a homogeneous polymeric melt that is subsequently forced through the extrusion die to form a continuous-length having a desired shape. Once cooled, the extrudate may be would onto a reel or cut into pieces of a desired length. Subsequent thermal processing steps may be used to modify or shape the extrudate into a desired configuration.

Extrusion processes are often employed in producing tubing for medical applications, such as, tubing for various catheters, particularly angiography or guiding catheters, balloon angioplasty and stent delivery catheters, and medical balloons, especially high pressure dilatation and stent delivery balloons, as well as in tubing for implantation or insertion in the body for long periods of time and other applications where mechanical, physical, chemical, electrical or thermal properties are critical to the function to the finished medical device.

Depending on the medical application, medical tubing used for catheters should possess a combination of desirable characteristics such as axial and torsional strength, a.k.a. pushability and torqueability, bondability, biocompatibility and/or lubricity. However, such a combination of characteristics may not be readily achievable with tubing made of only a single material. For instance, medical tubing that is to be used in making angioplasty and stent delivery catheters desirably may be formed from an inherently slippery or low-friction polymer that also may be different to effectively bond to the material of conventional balloons due to the chemical incompatibility between the materials to be bonded. Alternatively, polymer materials that demonstrate good bonding characteristics with balloons typically must be coated with a lubricant on the interior surface so that the interior surface of the catheter tubing is sufficiently low-friction for passing over a guidewire or other medical device, often necessitating an additional manufacturing step.

To overcome this and other problems, it is known to provide the desired characteristics for intravascular catheters by utilizing multilayered medical tubing. In one instance, such multilayered tubing is co-extruded or overjacket extruder to have an outer layer of a bondable material, such a polyamide, polyethylene, polyurethane, or poly(ethylene terephthalate) (PET), and an inner layer of a low-friction polymer such as polytetrafluoroethylene (PTFE), fluorinated ethylene-propylene (FEP), perfluoroalkoxy polymer resin (PFA) or high density polyethylene (HDPE). In another instance, a multi-layered tubing composed of an outer layer of a bondable material, a core layer of a low-friction material, and an intermediate tie layer are co-extruded using three extruders simultaneously feeding a single die/head.

Although multilayer tubing for use in medical devices may be co-extruded, maintaining the various polymers at optimum processing conditions to prevent degradation of the melts during the extrusion process is often difficult and, if unsuccessful, may result in delamination of the layers and/or a change in properties of the finished tubing, such as a decrease in tensile strength, increased brittleness, and/or insufficient flexibility. Thus a need exists in the art for medical tubing that exhibits the desired characteristics of strength, resistance to bending and torsional kinks, pushability, torqueability, bondability and/or lumen lubricity but that is made by a simpler process.

### BRIEF SUMMARY OF THE INVENTION

The invention is [to be finalized after approval of claims].

### BRIEF DESCRIPTION OF DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a schematic representation of a conventional medical tubing extrusion line.

FIG. 2 is a schematic representation of a medical tubing extrusion line in accordance with an embodiment of the present invention.

FIG. 3 is a schematic representation of a portion of a medical tubing extrusion line in accordance with another embodiment of the present invention.

FIG. 3A is a cross-sectional view taken along line A-A of FIG. 3.

FIG. 4 is a schematic representation of a portion of a medical tubing extrusion line in accordance with another embodiment of the present invention.

FIG. 4A is a cross-sectional view taken along line A-A of FIG. 4.

### DETAILED DESCRIPTION OF THE INVENTION

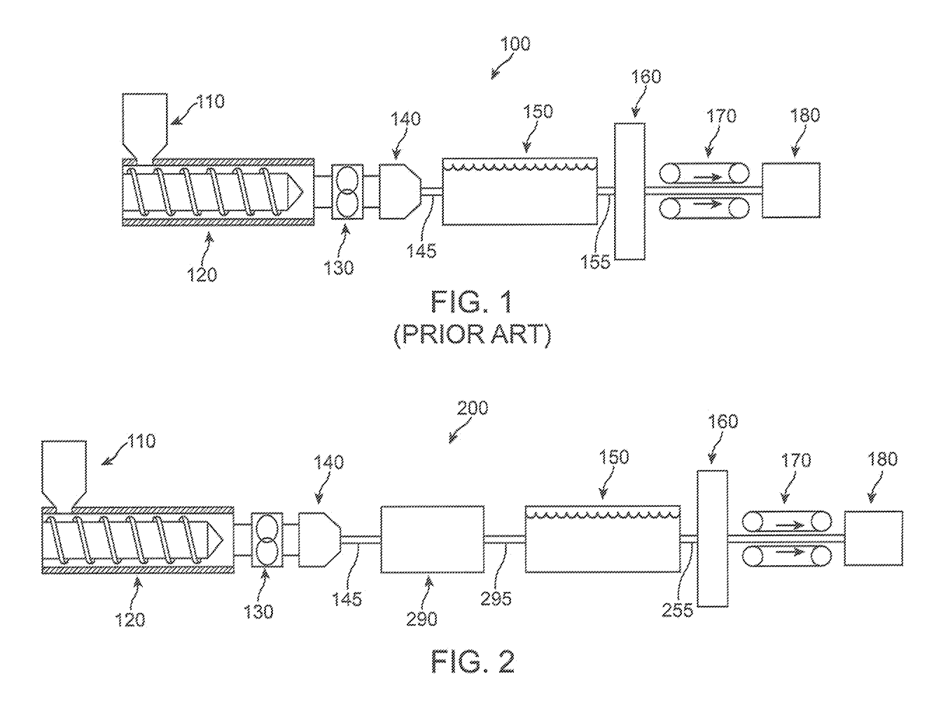

FIG. 1 is a schematic representation of a conventional medical tubing extrusion line 100 having a resin hopper 110, which may also function as a resin dryer, feeding a horizontal extruder 120. Extruder 120 includes a heated barrel and a screw that rotates within the barrel to mix, create frictional heat and feed molten resin through extrusion die or head 140. Optionally, and as illustrated in FIG. 1, a melt pump 130 may be included to provide molten resin at constant pressure and flow rate to extrusion die 140. Extrusion die 140 sits at an end of extruder 120 and is the point where the extrudate exists into air, and promptly into a cooling trough 150. Extrusion die 140 forms the initial exterior shape of the tubing and, to form hollow tubing, typically surrounds a mandrel or pin that forms the initial interior shape of the tubing. As the hot extruded tubing or extrudate 145 exists the annular space between the pin and extrusion die 140, its inner and outer dimensions are typically drawn down to its finished tube dimensions by action of a puller 170 positioned downstream of a cooling trough or system 150. Controlled air pressure may also be supplied to the inside of hot extrudate 145 via an air channel through the pin. Cooling trough 150 may utilize water as the cooling medium or, alternatively, air cooling may be used. After the cooled extruder tubing product 155 exits cooling trough 150, it may pass through a measuring gauge 160 to assure its outer diameter is within acceptable parameters. Finally, extruded tubing product 155 may be cut into lengths or wound into a spool by a cutter or winder 180, respectively.

FIG. 2 is a schematic representation of a medical tubing extrusion line 200 in accordance with an embodiment of the present invention. In addition to the apparatus discussed with reference to extrusion line 100 of FIG. 1, extrusion line 200 includes an inline particle deposition system 290. Deposition system 290 is positioned on extrusion line 200 to deposit a solid particulate material on the warm, tacky outer surface of extruded tubing 145 proximate to the exit of tubing 145 from extrusion die/head 140. In an embodiment, deposition system 290 is arranged to deposit a continuous layer of solid particulate material on the tacky outer surface of extruded tubing 145. In various embodiments, the solid particulate material may be a metallic, polymeric or ceramic material in the form of, e.g., powder or metal filings. By “proximate to the exit of extrusion die/head 140,” it is meant that the deposition of solid particulate material onto the outer surface of extruded tubing 145 occurs very close in space or time, or, at or within a short distance in space or time, from extruded tubing 145 exiting extrusion die/head 140. In turn, extruded tubing sub-product 295, having solid particulate material on the outer surface thereof, exists particle deposition system 290 to be cooled within cooling system 150. Accordingly, extruded tubing product 255 then exits cooling system 150 with the solid particulate material secured thereto to be subsequently wound or cut into appropriate lengths.

Inline particle deposition system 290 may consist of a chamber or spray station having one or more nozzles or spray heads, such as in a pressurized spraying process. The nozzles or spray heads may be arranged to spray solid particulate material perpendicular to or at a range of angles with respect to a longitudinal axis of tacky extruded tubing 145, to provide a continuous layer of particulate on extruded tubing 145 as it moves along extrusion line 200. In addition, various vacuum deposition processes may be useful in inline particle deposition systems according to embodiments of the present invention.

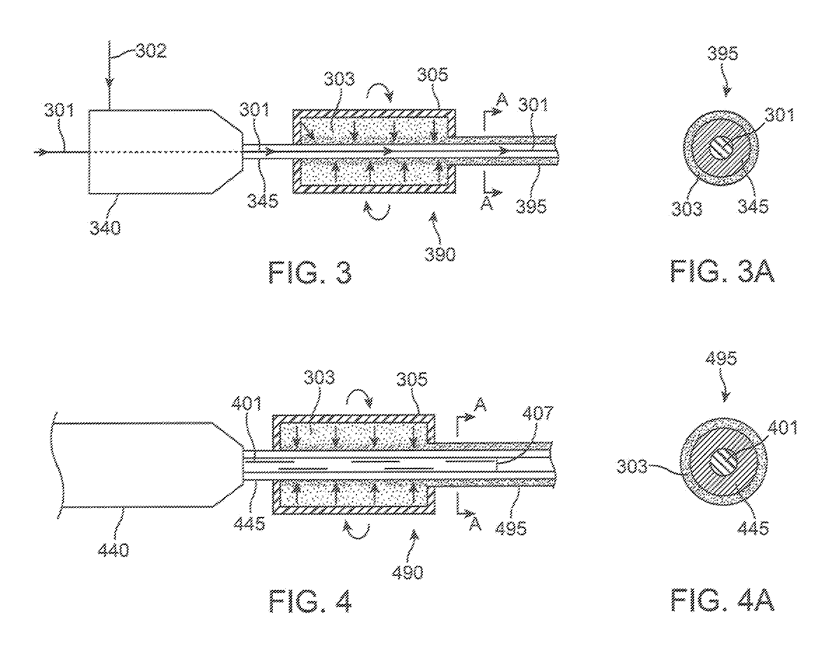

In an embodiment shown in FIGS. 3 and 3A, inline particle deposition system 390 utilizes a magnetic process to deposit a solid particulate 303 of or including a magnetizable material, i.e., a material attracted to magnetic materials, e.g., ferrimagnetic materials such as magnetite or ferromagnetic materials such as cobalt, nickel or iron, onto the tacky outer surface of extruded tubing 345. Extrusion die/head 340 is of the wire-covering cross head type, which includes a central passageway for feeding a core rod 301 of or including a magnetic material through extrusion die/head 340 to be covered by the polymeric material 302 forming extruded tubing 345. In an embodiment, extruded tubing 345 enters a tumbler or other chamber 305 of inline particle deposition system 390 that hold and distributes/tumbles magnetizable solid particulate 303, so that the solid particulate 303 may be attracted to magnetic core rod 301 within extruded tubing 345 to thereby form a deposited layer of solid particulate 303 thereon. To distribute particulate 303 around extruded tubing 345, chamber 305 may move, e.g., vibrate or rotate, as indicated by arrows in FIGS. 3 and 4. In a further embodiment, solid particulate 303 may be a magnetic material and the core material may be magnetizable to achieve the same result. In turn, extruded tubing sub-product 395, having magnetizable solid particulate material on the outer surface, thereof, exits particle deposition system 390 to be cooled within a cooling system (not shown). At some point during processing, core rod 301 is removed from extruded tubing sub-product 395 by any of the processes known to those skilled in the art, leaving a hollow passageway in the finished medical tubing product. In various embodiments, core rod 301 may be one of a filled plastic beading or metallic rod or wire that is made entirely or partially of magnetic or magnetizable materials.

In an embodiment shown in FIGS. 4 and 4A, inline particle deposition system 490 utilizes a magnetic process to deposit a magnetic or magnetizable, e.g., ferrous, solid particulate 303 onto the tacky outer surface of extruded tubing 445. However in this embodiment, extrusion die/head 440 includes a stationary, magnetic or magnetizable core rod 401 that extends from die/head 440 into or through tumbler/chamber 305 of inline particle deposition system 490. Stationary core rod 401 may act as a mandrel or pin to form the initial interior diameter or profile of tubing 445, as described above. Core rod 401 extends within extruded tubing 445 as extruded tubing 445 passes through chamber 305, so that magnetic or magnetizable solid particulate 303 may be magnetically attracted to core rod 401. As such, a layer of solid particulate 303 is deposited on an outer surface of extruded tubing 445 as the tubing passes through chamber 305. In turn, extruded tubing sub-product 495, having magnetizable or magnetic solid particulate material on the outer surface thereof, exits particle deposition system 490, eventually clearing an end 407 of stationary core rod 401, to be cooled within a cooling system (see cooling system 150 in FIGS. 1 and 2).

A medical tubing made with embedded magnetizable particles, such as ferrous particles, according to embodiments of the present invention may be beneficial for viewing such tubing by magnetic resonance imaging (MRI) during use in medical procedures.

Although a horizontal extruder 120 is shown in the embodiment of FIG. 2, it would be understood by one of ordinary skill in the art that for certain applications the use of a vertical extruder may be beneficial to avoid lateral gravitational force in assuring the production of uniformly thin-walled tubing.

A process according to an embodiment of the present invention may be used to produce medical tubing having a low-friction inner surface. In such an embodiment, the selection of a solid particulate material for deposition on tacky extruded tubing 145 may be made to promote adhesion between the polymeric material of extruded low-friction tubing 145 and a second polymer, which is subsequently attached as an outer sleeve or a second extruded layer, e.g., an over-jacket extrusion, over extruded tubing 145. Extruded tubing 145 may be made of a polyamide, such as Nylon 12, Nylon 6/6 or other nylon copolymers, as well as polyether block amides such as those commercially available under the trademark PEBAX®, a registered trademark of the Arkema Corporation. Extruded tubing 145 may then have a solid particulate material of carbon, titanium dioxide or a zeolite deposited on an outer surface thereof to form extruded tubing product 255. Subsequently, an outer sleeve or layer of a low-friction polymer, such as high density polyethylene (HDPE), fluorinated ethylene-propylene (FEP), perfluoroalkoxy polymer resin (PFA) or polytetrafluoroethylene (PTFE), may be readily adhered to extruded tubing product 255 due to interaction between the solid particulate material and the polymeric material of the outer layer.

A process according to another embodiment of the present invention may be used to produce medical tubing having a low-friction inner surface, wherein the selection of the deposited particulate material may be made to promote adhesion between the low-friction polymeric material of extruded tubing 145 and a second polymer used to form an outer sleeve or layer on extruded tubing 145. In such an embodiment, extruded tubing 145 may be made of a low-friction polymeric material, such as FEP, HDPE, PFA or polyethylene. A solid particulate material of a thermoplastic material having a lower melt temperature than the low-friction polymeric material of extruded tubing 145, which is also attractive for bonding to the material of the outer layer, may then be deposited on an outer surface of tubing 145 to form extruded tubing product 255. Subsequently, an outer sleeve or layer of a second polymeric material, such as, a polyamide, Nylon 12, Nylon 6/6 or other nylon copolymer, polyether block amide or polyurethane, may be readily adhered to extruded tubing product 255 due to interaction between the deposited solid particulate material, which in this embodiment may be carbon, titanium dioxide or a zeolite or a blend of polyether block amide and low density polyethylene (LDPE), and the polymeric material of the outer layer.

In an embodiment, the selection of a solid particulate material for deposition on tacky extruded tubing 145 may be made to provide radiopacity to extruded tubing 145, as an outer layer thereof or as a radiopaque layer between extruded tubing 145 and an outer layer that may be subsequently attached. In an embodiment, a solid particulate material of bismuth subcarbonate, barium sulfate or a biocompatible metal having a high coefficient of x-ray absorption, such as precious metals or refractory metals, e.g. tungsten, tantalum, rhenium or alloys thereof may be deposited on extruded tubing 145 to form extruded tubing product 255 having enhanced radiopacity.

In another embodiment, the selection of a solid particulate material for deposition on tacky extruded tubing 145 may result in improved tensile strength, elongation and stiffness properties of a final tubing product by improving adhesion of an outer jacket of a different material to extruded tubing 145.

The medical tubing produced by embodiments of the present invention may be used, for example, in medical devices suitable for percutaneous transluminal use, such as guide catheters, diagnostic catheters, stent delivery catheters or balloon angioplasty catheters.

While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. A method of making an extruded tubing product comprising:
forcing a polymeric material through an extrusion die to produce an extruded tubing;
depositing a solid particulate material onto a tacky outer surface of the extruded tubing proximate to the extruded tubing exiting the extrusion die; and
cooling the extruded tubing with the solid particulate material attached thereto to form an extruded tubing product.

2. The method of claim 1, wherein the solid particulate material is selected to promote adhesion of a second polymeric material to the outer surface of the extruded tubing product.

3. The method of claim 2, wherein the polymeric material of the extruded tubing is high density polyethylene and the second polymeric material is polyether block amide copolymer.

4. The method of claim 3, wherein the solid particulate material is selected from a group consisting of carbon, titanium dioxide and zeolite.

5. The method of claim 1, wherein the solid particulate material is selected to provide radiopacity to the extruded tubing product.

6. The method of claim 5, wherein the solid particulate material is selected from a group consisting of barium sulfate, bismuth subcarbonate, rhenium, tantalum or tungsten.

7. The method of claim 1, wherein the solid particulate is deposited using a vacuum deposition process.

8. The method of claim 1, wherein the solid particulate is deposited using one of a nozzle or spray head.

9. The method of claim 1, wherein the extruded tubing is formed over a core rod of a magnetic material.

10. The method of claim 9, wherein the solid particulate material is of a magnetizable material that is deposited on the tacky outer surface of the extruded tubing by magnetic attraction to the core rod within the extruded tubing.

11. A tubing for use in a medical device comprising:
a first extruded layer formed from one of fluorinated ethylene-propylene, high density polyethylene, and perfluoroalkoxy polymer resin and having a particulate material on an outer surface thereof; and
a second layer of a polymer joined to the first extruded layer by bonding with the particulate material, wherein the particulate material is selected from a group of materials consisting of barium sulfate, bismuth subcarbonate, carbon, cobalt, iron, magnetite, nickel, rhenium, tantalum, titanium dioxide, tungsten and zeolite.

12. The tubing of claim 11, wherein the polymer is polyether block amide copolymer.
